(19) United States
(12) Patent Application Publication
(10) Pub. No.: US 2002/0048743 A1
(43) Pub. Date: Apr. 25, 2002

(54) Interactive template for animated surgical technique CD-ROM

(75) Inventors: Reinhold Schmieding, Naples, FL (US); Cindy S. Obrecht, Naples, FL (US); Nancy McLaughlin, Naples, FL (US); Jeffrey Wyman, Naples, FL (US)

Correspondence Address: OSTROLENK FABER GERB & SOFFEN, 1180 AVENUE OF THE AMERICAS, NEW YORK, NY, 100368403

(73) Assignee: Arthrex, Inc.

(21) Appl. No.: 09/981,754

(22) Filed: Oct. 19, 2001

Related U.S. Application Data
(60) Provisional application No. 60/241,794, filed on Oct. 20, 2000.

(51) Int. Cl. G09B 23/28

(52) U.S. Cl. 434/262

(57) ABSTRACT

An interactive template to be used as an information guide and training aid for surgical techniques facilitates learning of a surgical technique by providing an animated segment using diagrams, drawings, and/or graphics which allow a user to clearly and easily visualize each step in the procedure. The interactive template may be a compact disc (“CD”) or a collection of “pages” accessible through a network such as an intranet or the Internet. Upon accessing the template, the user is presented with a selection tool by which to select a category of information desired to be viewed, such as a list of surgical procedures or instrumentation, a video or animated demonstration of a selected procedure or on the use of a selected instrument, literature on a selected procedure, a glossary, information about the sponsoring company, etc.

This application claims the benefit of U.S. Provisional Application Serial No. 60/241,794, filed on Oct. 20, 2000.

### BACKGROUND OF THE INVENTION

1. Field of the Invention

The present invention relates to an interactive template to be used as an information guide and training aid for surgical techniques.

2. Description of the Related Art

Traditionally, in order to train medical personnel to perform various surgical techniques or to use new equipment therefor, it is necessary to either schedule a classroom and/or lab session for an instructor to teach the personnel either as a group or in a one-on-one situation. Such training often involves significant travel and related expenses, especially when a separate session must be scheduled for each separate technique on which the personnel is to be trained.

Other training vehicles typically used include written literature and video presentations. Upon reading or viewing such materials, however, if the surgeon or technician has questions or requires additional information about any aspect of the procedure or the instrumentation, significant effort must be expended to track down the desired information by researching other articles, contacting the appropriate institutions for assistance, etc.

A need therefor exists to provide an effective means for training medical personnel in a way which streamlines the learning process and any available information on the subject being taught.

### SUMMARY OF THE INVENTION

It is an object of the present invention to provide an interactive template to be used as an information guide and training aid for surgical techniques. The interactive template of the present invention facilitates learning of a surgical technique by providing an animated segment using diagrams, drawings, and/or graphics which allow a user to clearly and easily visualize each step in the procedure.

Other features and advantages of the present invention will become apparent from the following description of the invention which refers to the accompanying drawings.

### BRIEF DESCRIPTION OF THE ILLUSTRATIONS

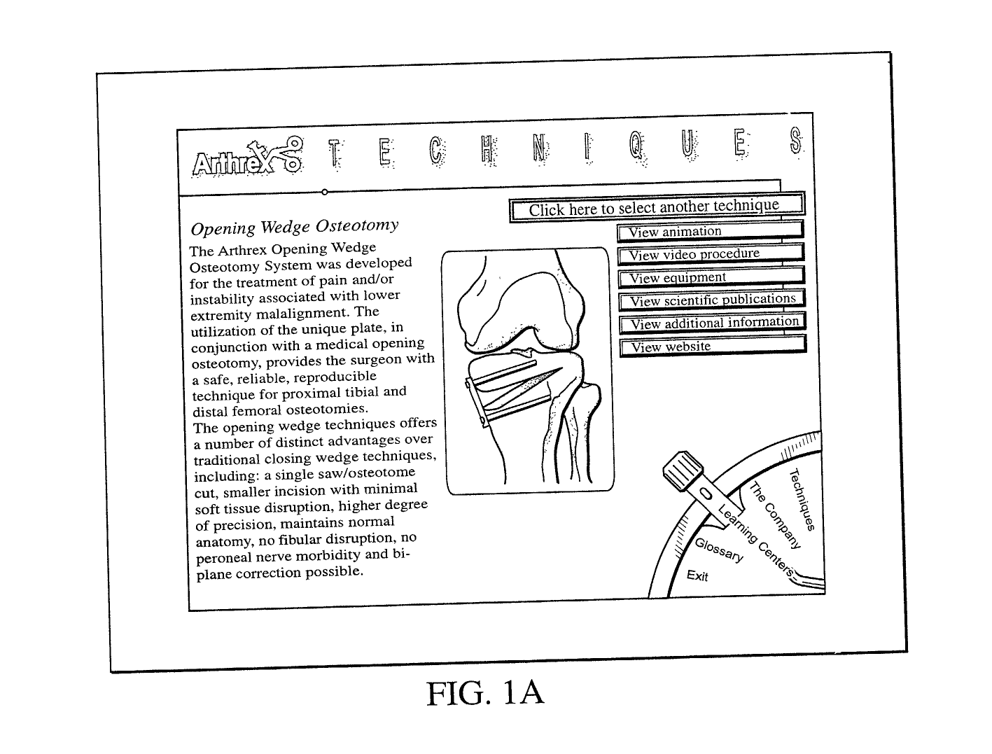

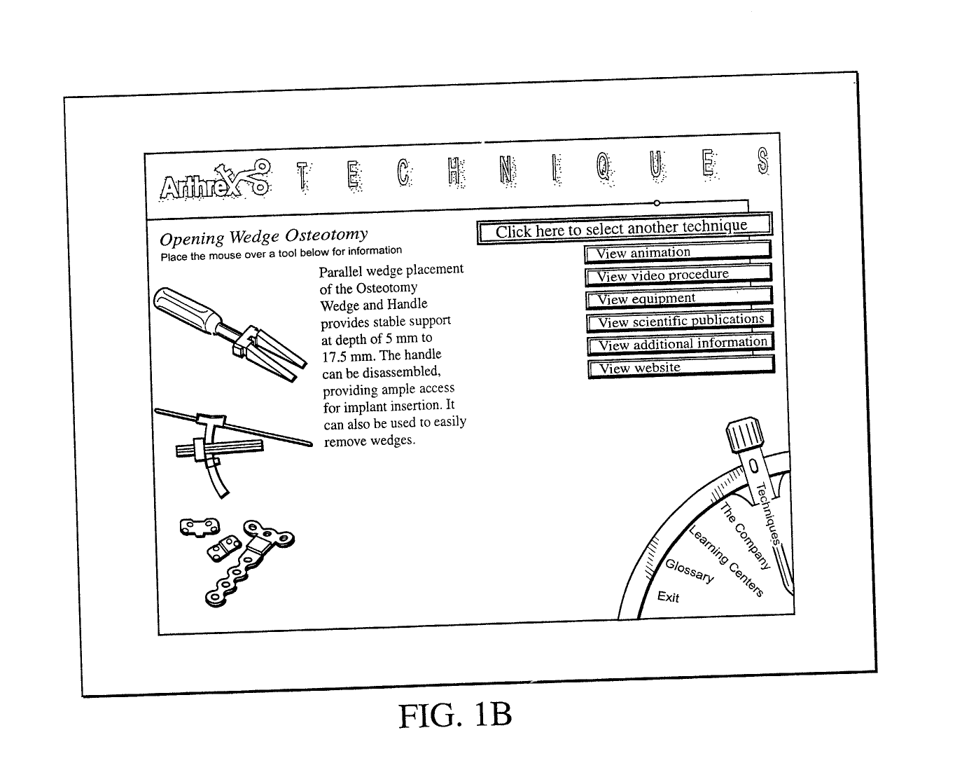

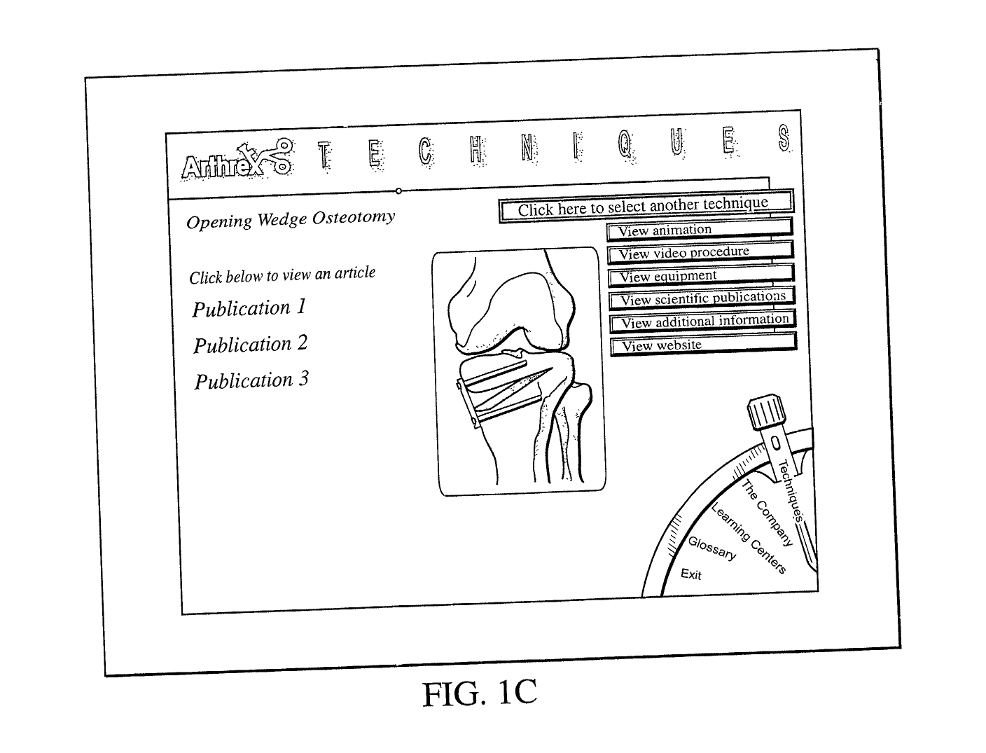

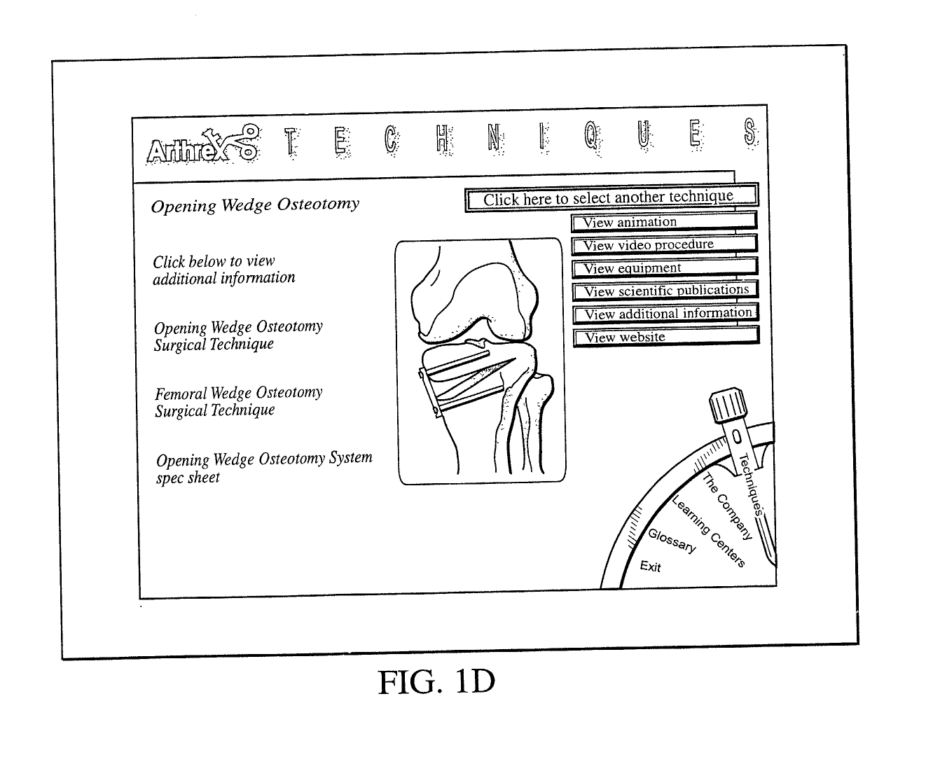

FIG. 1A is a page in an exemplary embodiment of the inventive template showing a description of a selected surgical technique.

FIG. 1B shows a display of the instruments used to perform the selected surgical technique and a description of a selected one of the displayed instruments.

FIG. 1C shows a displayed list of scientific articles relevant to the selected surgical procedure.

FIG. 1D shows a displayed list of additional information pertaining the selected surgical procedure.

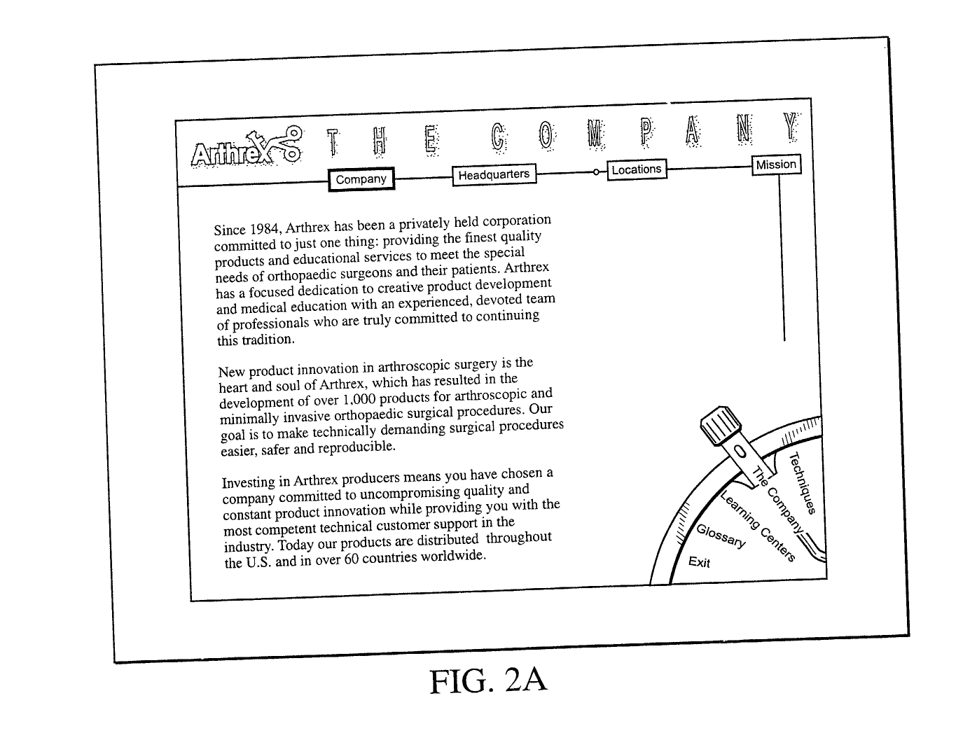

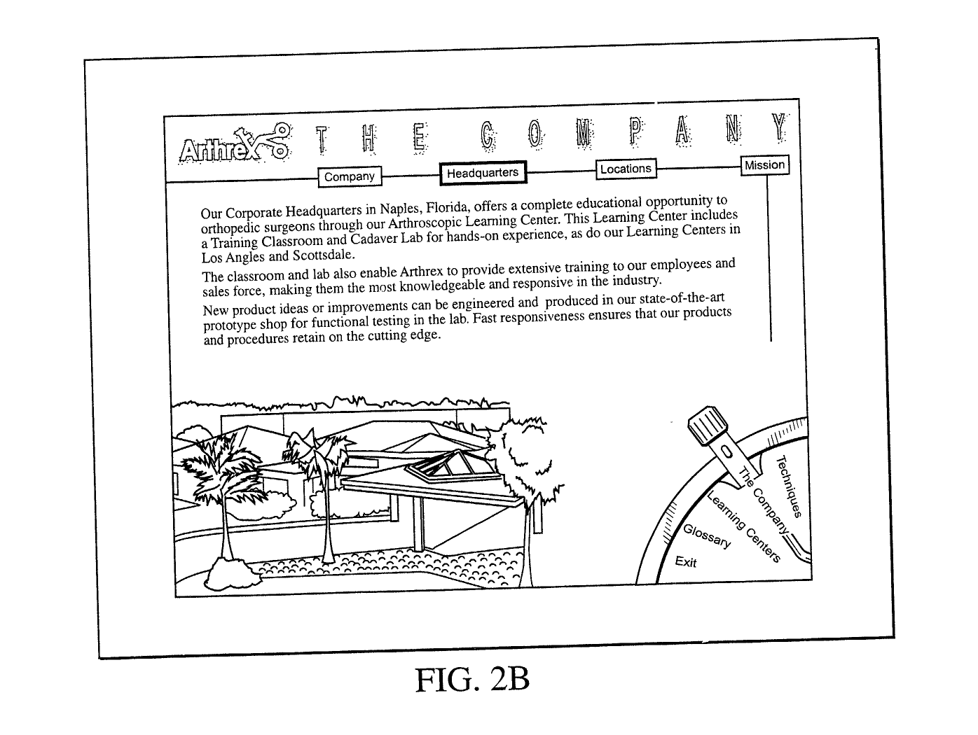

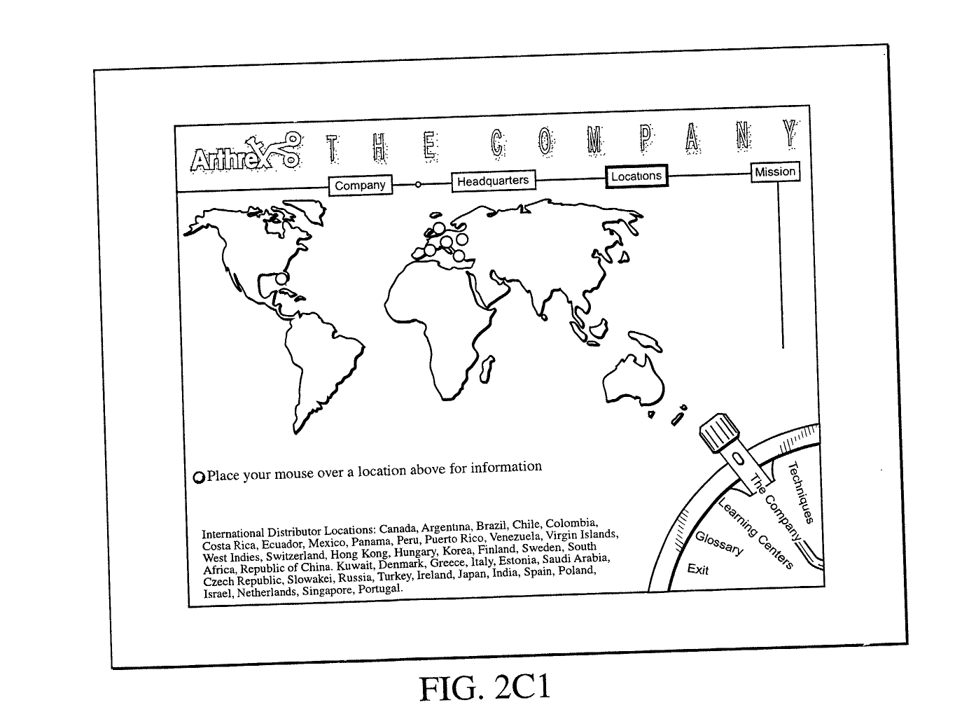

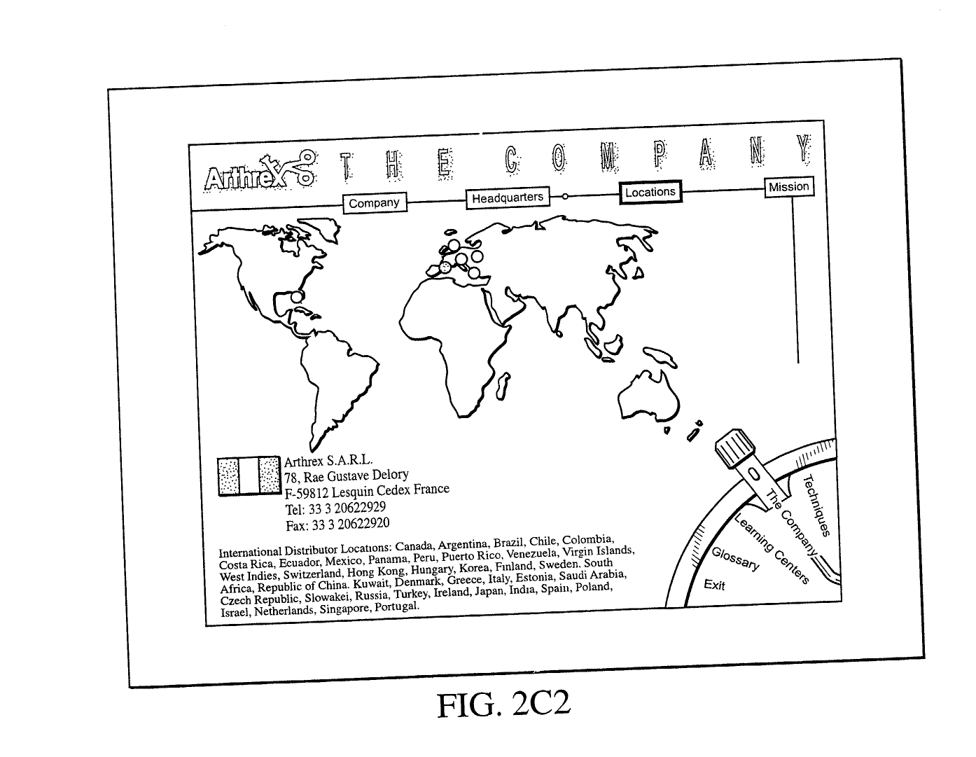

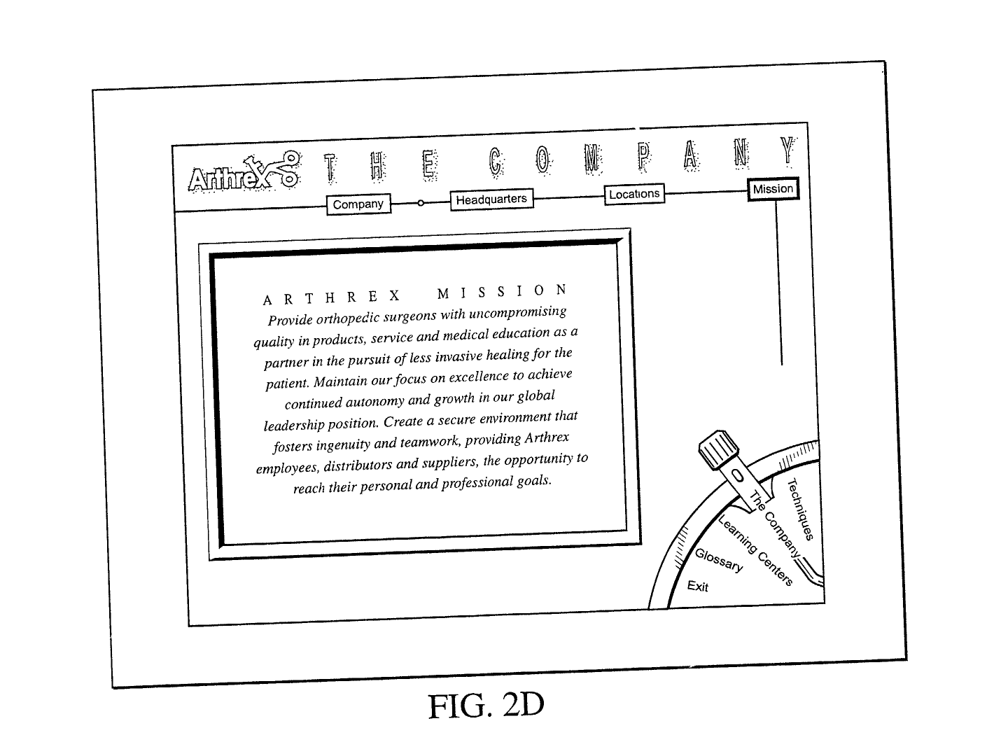

FIG. 2A shows an information page providing information about a company sponsoring the interactive template.

FIG. 2B shows an information page providing information about the corporate headquarters of the sponsoring company.

FIG. 2C1 shows an information page providing general information about other regional corporate locations of the sponsoring company.

FIG. 2C2 shows an information page providing specific information about a selected one of the regional corporate locations.

FIG. 2D shows an exemplary page describing the corporate mission of the sponsoring company.

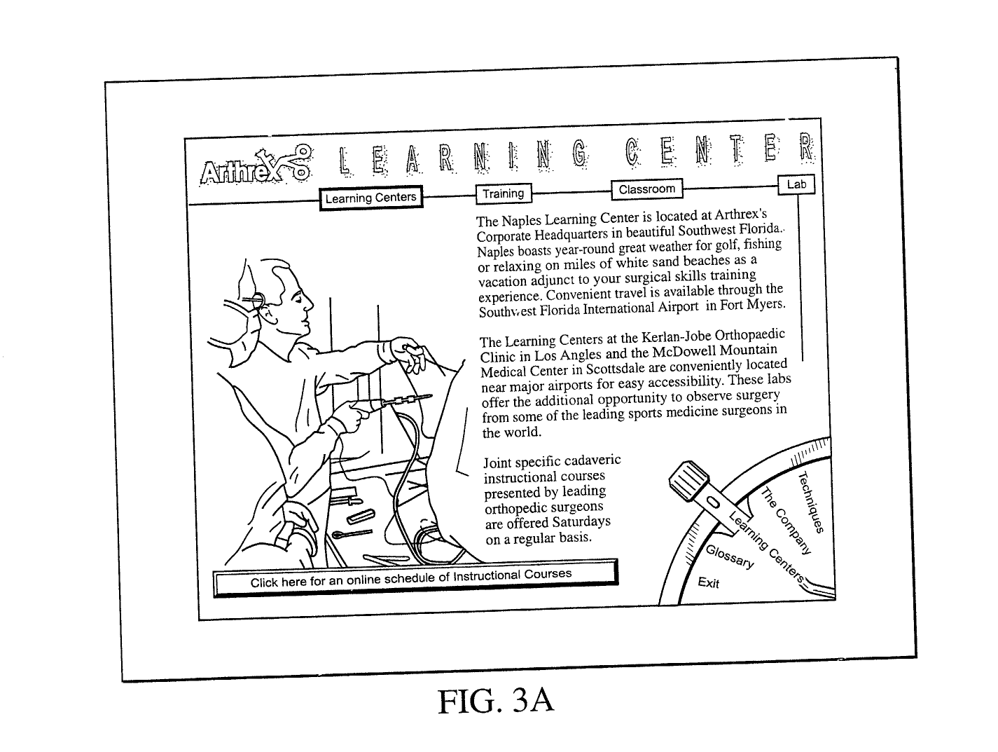

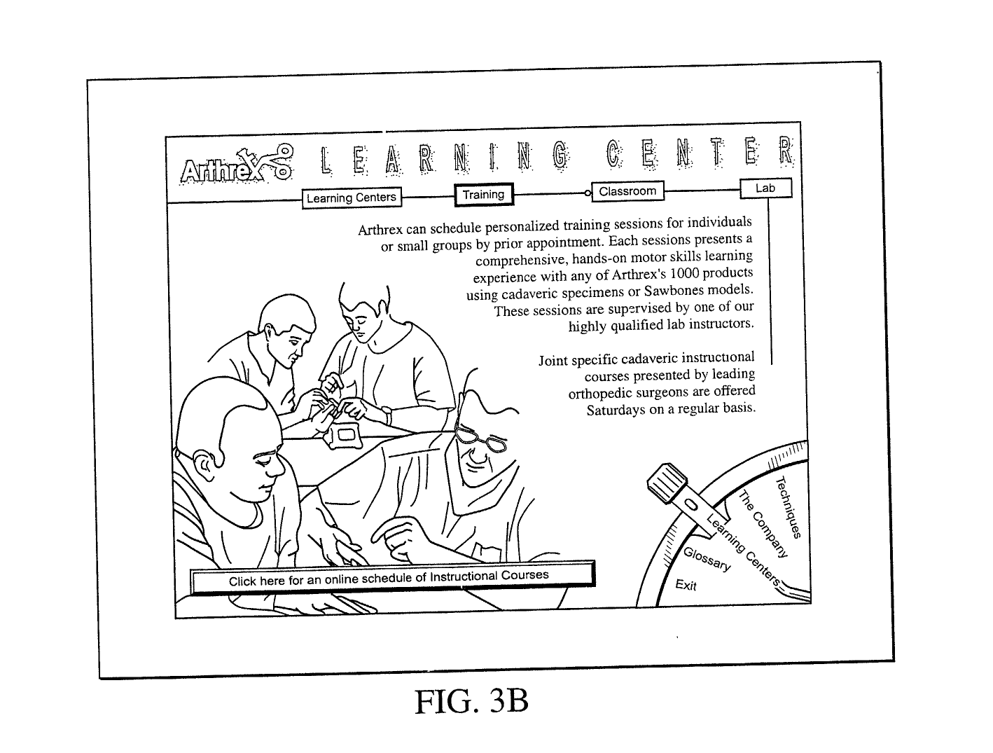

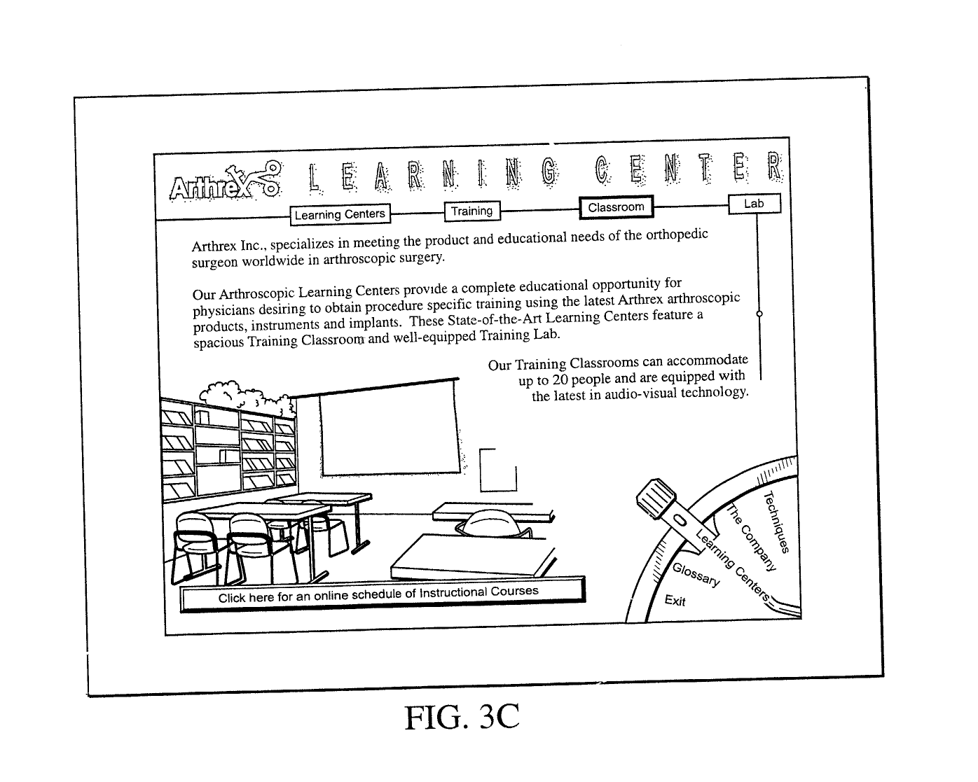

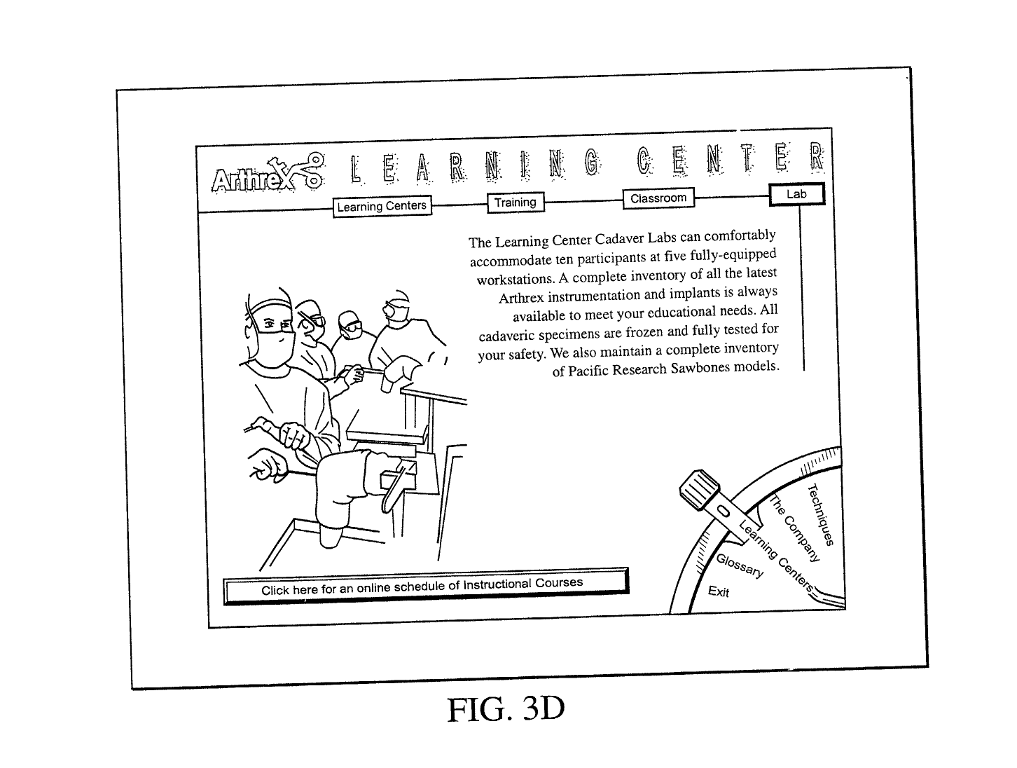

FIG. 3A shows a display page providing information about the instruction centers operated by the sponsoring company.

FIG. 3B shows an information page describing the training process for surgeons learning to practice the techniques described in the inventive template.

FIG. 3C shows an information page providing a description of the learning environment in which surgeons are taught the surgical procedures described in the interactive template.

FIG. 3D shows an information page providing a description of another learning environment in which surgeons are taught the surgical procedures described in the interactive template.

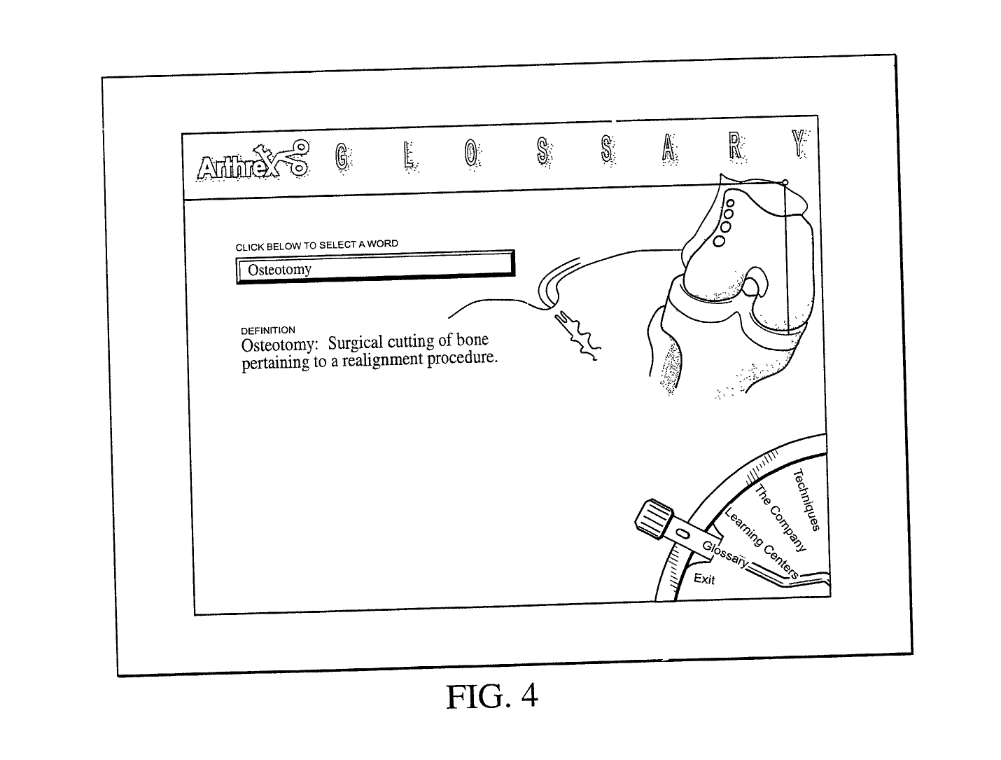

FIG. 4 illustrates a page in the glossary feature of the inventive template.

### DETAILED DESCRIPTION OF EMBODIMENTS OF THE INVENTION

The interactive template of the present invention may be a compact disc (“CD”) or a collection of “pages” accessible through a network such as an intranet or the Internet. Preferably, the template is a CD which focuses on one or a selected group of surgical techniques.

If the template is provided in the form of a CD, the template is accessed by inserting the CD into the appropriate drive in a desktop computer or user workstation, whereupon the template is executed via a media player interface such as Quicktime®, Microsoft Windows® Media Player, etc. Alternatively, an authorized user may access the template through a corporate intranet or through the Internet.

Upon accessing the template, a user is presented with a selection tool by which to select a category of information desired to be viewed. In the lower right hand corner in FIG. 1A, the selection options include a “Techniques” section, a section entitled “The Company,” a section entitled “Learning Centers,” a “Glossary” section, and an “Exit” option. The selection tool is preferably always present on each page of information viewed by the user, to facilitate access to the other information categories. In the present example, the selection tool is creatively represented as a marking hook, which is a standard instrument commonly used in the field of arthroscopic surgery, the art area of the surgical techniques described in the present example. However, the selection tool may be represented by any creative embodiment using elements known in the relevant field of art or in any other manner desired by the sponsor of the template.

When the “Techniques” position is designated with the selection tool, as seen in FIG. 1B, the template displays a brief description of a first surgical technique. For example, the technique described in FIG. 1A is an opening wedge osteotomy.

Another selection menu is provided in the upper right hand region of surgical technique description page, offering selection options to view information about another surgical technique, an animation segment demonstrating the procedure, a video recording of the surgical technique being performed on a patient, information about the equipment used to perform the technique, scientific publications about the procedure, additional information relevant to the procedure, or to be directly linked to a website maintained by the company providing the information in the interactive template. Like the main selection tool, this second selection menu may be presented as a creative representation or in a more traditional manner.

Another technique may be selected by clicking on the appropriate option listed in the second selection menu with the computer mouse or designating with other selection means provided by the user's workstation or computer.

Selection of the “View Animation” option executes an animated diagram using readily understandable graphics and drawings to demonstrate the performance of the surgical technique. Preferably, the animated segment is computer-generated using engineering specification drawings of the instrumentation used in the technique, so that the true proportional relationships and appearances are accurately shown as the elements are moved relative to each other through the entire progression of the animated clip. By viewing such an animated segment, the user can easily visualize the technique in a manner which is clearly presented and easy to follow, without the presence of distracting background scenes or clutter which are often present in a video or live demonstration of the technique. The animated segment also provides an advantage over static images or photographs in that the user is provided with a more complete picture demonstrating the full range of performance of the technique.

In producing the animation segment, drawing images of each of the elements from every view angle, i.e. perspective, front, back, side, end, etc., are inputted to an appropriate CAD software program, and the program then “moves” the elements three-dimensionally in accordance with the performance of the demonstrated procedures. Alternatively, the animated segment can be produced from a series of drawings showing a still-image of the technique at each step, whereupon the software program then “connects” the drawings into a smooth, moving picture segment. An example of a computer software program usable for creating such an animated clip is Pro/ENGINEER® (Parametric Technology Corp.).

Preferably, the animated segment is accompanied by an audio narrative providing step-by step instruction and/or explanation of the procedure. Also, the two selection menus may or may not be present in the displayed image during execution of the animation clip. If they were removed from view during execution of the animation clip, the selection menus are returned to the display screen upon termination of the animation clip.

Similarly, selection of the “View Video Procedure” option executes a video recording of the surgical procedure being performed on a patient. Again, an audio recording, narrative or related discussion may accompany the video clip if desired.

As shown in FIG. 1B, selection of the “View Equipment” option displays the instruments used to perform the selected procedure. Placement of a mouse cursor over each instrument causes a description of that piece of equipment to be displayed. This is known as a “rollover” or “mouseover” display in the interactive media technology. Of course, a description of each instrument may be displayed by other known methods of highlighting and selecting, such as by “clicking” on the image of the selected instrument, or by repeatedly pressing the “Tab” key, spacebar, or an arrow key on the keyboard.

Selection of the “View Scientific Publications” option is illustrated in FIG. 1C, in which a hyperlinked list of relevant publications is listed. Clicking on any of the listed publications will display the selected publication, whereupon the user can read the publication through the inventive template or download or print out the publication for reading at a later time. The selected publication may be displayed either by opening another application window on top of the one in which the interactive template is running, or the template display may be changed to display the publication. In the latter alternative, a link should be provided in the viewable area which allows the user to return to the previously viewed page after the user is finished reading, printing or downloading the publication.

Similar to the “View Scientific Publications” feature, the “View Additional Information” selection option in the second selection menu may provide a display of another hyperlinked list of other references or information related to the designated surgical procedure, as shown in FIG. 1D.

Upon selection of the “View Website” option, the template automatically opens a browser application such as Microsoft Internet Explorer® or Netscape Navigator®, searches for a communication channel linking the user's computer or workstation to the intranet or Internet, such as an analog or digital dataline, and then connects the user's computer or workstation to the website of the company providing the information in the template, whereby the user may access any information available through the website such as further information about the company or within the field of the techniques demonstrated in the template which may be of interest to the user.

Using the primary selection tool in the present example, if the marking hook is moved to select “The Company” (for example, by clicking on the image of the marking hook with the user's computer mouse and dragging it to the desired position), the interactive template displays a general description about the company providing the interactive template (see FIG. 2A). A new secondary selection menu is also displayed which is also continuously present in each page within the “The Company,” allowing the user to view information about different aspects of the company.

For example, selection of the “Headquarters” option in the secondary menu changes the template to display information specifically about the corporate headquarters of the company, as illustrated in FIG. 2B. Selection of the “Locations” menu item displays a map of the world with pinpoints showing the corporate locations of the company, including the headquarters. General information of the regional offices is also provided in this page (FIG. 2C1). In this example, clicking on or rolling over each of the pinpoints representing the regional offices causes the template to display specific information about the selected regional office, such as contact information (FIG. 2C2).

In the present example, selection of the “Missions” item in the secondary menu displays a statement of the corporate mission (FIG. 2D).

When the primary selection tool is moved to the “Learning Centers” position as shown in FIG. 3A, the template displays information about the instruction centers operated by the sponsoring company. As before, a secondary selection menu is also displayed to allow the user to view information regarding different aspects of the company's training features.

Selection of the “Training” menu item, as shown in FIG. 3B, provides a description of a “hands-on” training process for teaching a user to perform the surgical techniques demonstrated in the interactive template.

FIG. 3C shows an information page displayed when “Classroom” is selected from the secondary menu. This page provides a description of the classroom facilities in which surgeons are given preliminary instruction in performing the surgical procedures described in the interactive template. Similarly, selection of the “Lab” item in the secondary menu displays an information page providing a description of the laboratory environment in which surgeons learn the surgical procedures described in the interactive template by “hands-on” training.

In any or all of the pages within the “Learning Centers” information category, a link may be provided either to a page within the company's website or to a database within the company to display an updated schedule of training courses for the surgical techniques demonstrated in the interactive template. Optionally, the user may also be enabled to register for a training course at one of the instructional facilities.

Returning to the primary selection tool, selection of the “Glossary” item displays a pull-down list of technical terms relevant to the subject matter demonstrated in the template (FIG. 4). Highlighting or selection of a desired term prompts the template to display a definition of that term. Of course, other known methods may be used for organizing or indexing the terms in the glossary.

To exit the interactive template and terminate the media player application, the “Exit” option is selected in the primary selection tool.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An instruction aid for training a user to perform a surgical technique, comprising:
an interactive template accessible by a user;
an animated demonstration of the surgical technique provided in the interactive template;
a video recording demonstrating performance of the surgical technique on a patient, provided in the interactive template; and
information relating to any surgical instruments necessary for performing the surgical procedure, provided in the interactive template.

2. The instruction aid according to claim 1, wherein the interactive template further includes access to published references relating to the surgical technique.

3. The instruction aid according to claim 1, wherein the interactive template further includes a link to a website to be accessed through a network communication channel.

4. The instruction aid according to claim 1, wherein the interactive template further includes a link to a schedule of training courses for the surgical technique.

5. The instruction aid according to claim 4, wherein the link to the training schedule enables a user to interactively register for a training course with a training facility.
